(19) United States
(12) Patent Application Publication
(10) Pub. No.: US 2020/0324751 A1
(43) Pub. Date: Oct. 15, 2020

(54) Method for Monitoring the Braking Force in a Vehicle

(71) Applicant: Robert Bosch GmbH, Stuttgart (DE)

(72) Inventors: Andreas Englert, Untergruppenbach (DE); Tobias Putzer, Bad Friedrichshall (DE)

(21) Appl. No.: 16/303,517

(22) PCT Filed: Mar. 24, 2017
(86) PCT No.: PCT/EP2017/057076

§ 371 Date: Nov. 20, 2018

(30) Foreign Application Priority Data
May 24, 2016 (DE) 10 2016 209 042.9

(51) Int. Cl. B60T 13/74; B60T 17/22; B60T 8/171

(52) U.S. Cl. CPC B60T 13/741; B60T 8/171; B60T 17/221

(57) ABSTRACT

A method for monitoring a braking force in a vehicle that includes a braking system having a hydraulic vehicle brake and an electromechanical braking device with an electric brake motor configured to produce the braking force. The method includes enabling a hydraulic braking pressure of the hydraulic vehicle brake and the electric brake motor to act at the same time on the same brake piston of a wheel braking device. The method further includes producing a fault signal that represents a low hydraulic braking pressure in the hydraulic vehicle brake if a gradient of an electromechanical increase in braking force or a corresponding variable lies outside a permissible range of values.

The invention concerns a method for monitoring the braking force in a vehicle, the braking system of which comprises a hydraulic vehicle brake and at least one electromechanical braking device with an electric brake motor.

### PRIOR ART

In DE 10 2004 004 992 A1, a braking system for a vehicle is described that comprises a hydraulic vehicle brake for producing braking force in the normal braking mode and moreover an electromechanical braking device with an electric brake motor for producing a clamping force when the vehicle is at a standstill. The electric brake motor acts on the same brake piston as the hydraulic vehicle brake and displaces said brake piston against a brake disk.

From DE 10 2010 040 573 A1, it is moreover known, in the case of an electromechanical holding brake that is assisted by the hydraulic vehicle brake, to detect a fault in the hydraulics if a motor parameter of the electric brake motor lies outside a permissible range of values.

### DISCLOSURE OF THE INVENTION

The method according to the invention concerns a vehicle with a braking system comprising a hydraulic vehicle brake and at least one electromechanical braking device with an electric brake motor. In the normal braking mode, the vehicle is decelerated by operating the hydraulic vehicle brake. The electromechanical braking device is advantageously used for holding the vehicle at a standstill by actuating the electric brake motor and electromechanically producing a clamping force for holding the vehicle at rest.

The electromechanical braking device is integrated within a wheel braking device of the hydraulic vehicle brake, and the brake piston can be displaced towards the brake disk both by the hydraulic brake fluid and by the brake motor at the same time or mutually independently. The electromechanical braking device may also be used with the brake motor while the vehicle is being driven to reduce the speed of the vehicle.

The method is based on the braking situation in which both the hydraulic vehicle brake and the electromechanical braking device with the brake motor are operated at the same time to produce braking force. Accordingly, a hydraulic braking pressure and the electric brake motor are acting on the same brake piston in the wheel braking device at the same time and displace said brake piston towards a brake disk.

The hydraulic braking pressure is determined in the brake circuit in which the wheel braking device is disposed using a pressure sensor. In this case, the hydraulic braking pressure is sensed adjacent to a master brake cylinder of the hydraulic vehicle brake, which however has the disadvantage that in the case of a hydraulic line with a reduced or blocked flow cross section, for example in the case of a kinked or squashed hydraulic line, a setpoint braking pressure is determined adjacent to the master brake cylinder, which however is not applied to the wheel braking device, which remains unpressurised. In this case, the malfunction cannot be determined by sensor, so that the hydraulic pressure boost at the wheel braking device is absent and in the event of simultaneous operation of the electromechanical braking device only the electromechanical braking force of the brake motor is effective. In the case of the use as a parking brake, however, the problem can occur that the electromechanical braking force without the assistance of the hydraulic braking force is not sufficient to safely hold the vehicle at a standstill, especially on a slope.

Using the method according to the invention, malfunctions can be detected that are caused by too low and hence insufficiently high hydraulic braking pressure in the hydraulic vehicle brake. For this purpose, when applying the electric brake motor and the accompanying build-up of braking force, the rise of the braking force or a degree of undershooting or exceeding a permissible range of values corresponding thereto is investigated. Only if the electromechanical increase in braking force lies within the permissible range of values can a proper hydraulic braking pressure be assumed that is produced by the hydraulic vehicle brake. On the other hand, if the electromechanical increase in braking force and the value corresponding thereto lies outside the permissible range of values, a malfunction must be concluded, whereupon a corresponding fault signal is produced.

With the method according to the invention, the gradient of the electromechanical increase in braking force or the corresponding variable is compared with a reference value. The electromechanical increase in braking force occurs if the electric brake motor comes into contact with the brake piston and forces said brake piston against the brake disk. Subsequently, the electromechanical braking force increases linearly or at least approximately linearly. Said rise in the electromechanical braking force has a gradient that is compared with the associated reference value; the reference value marks the limit of the permissible range of values, possibly while taking into account a permissible tolerance band, wherein there is a fault in the hydraulic vehicle brake if the gradient of the electromechanical increase in braking forces lies outside the reference value while taking into account the tolerance value. Using the gradient of the electromechanical increase in braking force, it can be reliably assessed whether a sufficiently high hydraulic braking pressure is applied or there is an impermissible deviation. In the case a fault—if there is too low a hydraulic braking pressure—the gradient of the electromechanical increase in braking force is smaller than for a correctly functioning hydraulic vehicle brake. Said deviation can be determined and may lead to a fault signal. Said procedure has the advantage that the hydraulic braking pressure in the wheel braking device does not need to be sensed and yet a malfunction can still be detected.

According to an advantageous embodiment, the motor current of the electric brake motor is determined as the variable corresponding to the electromechanical increase in braking force and the assessment as to whether there is a malfunction in the hydraulic vehicle brake is based thereon. The motor current of the electric brake motor and the electromechanical braking force vary in synchronism, so that the motor current can form the basis of the assessment of the increase in braking force. Alternatively, it is also possible to determine the electromechanical braking force in a different way, for example to sense the braking force, for example using the displacement of the brake caliper, or to sense the stiffness of the brake caliper, and to base the assessment of a possible malfunction of the hydraulic vehicle brake thereon.

According to an advantageous embodiment, the gradient of the electromechanical increase in braking force is formed from the starting and end points of the increasing section. During the clamping process, the electric brake motor passes through a zero load phase without an increase in braking force. The electromechanical increase in braking force begins with the contact between the brake motor and the brake piston or between the brake piston and the brake disk; the starting point of the increase can for example be determined using the increase in the motor current. On reaching the setpoint electromechanical braking force, the brake motor is switched off; at the switch-off time, the brake current reduces to zero, which can also be detected. The start and end points of the electromechanical increase in braking force or the corresponding variable are thus determined and can form the basis of the determination of the gradient.

Alternatively, it is also possible to produce a line of best fit for the gradient during the increase in force and to compare said line of best fit with the reference value.

The permissible range of values can be determined empirically. It is for example possible to carry out a test run or a plurality of test runs in advance for the relevant wheel braking device and to store said test runs as reference values that determine the permissible range of values.

It is however also possible to determine the permissible range of values or the corresponding reference value from the stiffness of the brake caliper of the wheel braking device, which is a function of different parameters or characteristic values, for example the lining thickness, the temperature and any applied hydraulic bias pressure.

It may be that the stiffness of the brake caliper is determined during each clamping process, wherein advantageously the currently used value of the stiffness of the brake caliper is calculated as the mean value of at least two brake caliper stiffnesses determined at different points in time, for example from the current time step and the preceding time step, in each case relating to a clamping process.

According to a further advantageous embodiment, the variable corresponding to the gradient of the electromechanical increase in braking force is the stiffness of the brake caliper of the wheel braking device. The stiffness of the brake caliper can be determined as a function of different parameters and characteristic values or state variables, for example as a function of the temperature, the lining thickness of the brake lining and the hydraulic braking pressure. The stiffness of the brake caliper can currently be determined for each clamping process, wherein too low a hydraulic braking pressure exists in the case in which the stiffness of the brake caliper changes by an impermissible high value. There is also a fault in the hydraulic vehicle brake if the brake caliper stiffnesses between the different wheel braking devices differ from each other to an impermissible high extent.

According to yet another advantageous embodiment, the electromechanical increases in braking force in two different wheel braking devices are compared. In this case, in particular the increases in braking force in the two wheel braking devices on a common axle are compared with each other, preferably on the rear axle of the vehicle. If there are significant differences in the increases in braking force of the two wheel braking devices, this indicates a hydraulic fault in the wheel braking device with the smaller gradient of the increase in braking force.

According to a further advantageous embodiment, the hydraulic braking pressure is produced before the electromechanical increase in braking force. Said procedure ensures that the brake caliper is first loaded by the hydraulic braking pressure and is elastically deformed by the effect of the hydraulic braking pressure. Then the electromechanical build-up of braking force and correspondingly the additional loading of the brake caliper take place.

The steps of the method are carried out in a regulating unit or control unit, in which actuating signals are produced for actuating the different components of the braking system with the hydraulic vehicle brake and the at least one electromechanical braking device.

Further advantages and advantageous embodiments are to be found in the further claims, the description of the figures and the drawings. In the figures:

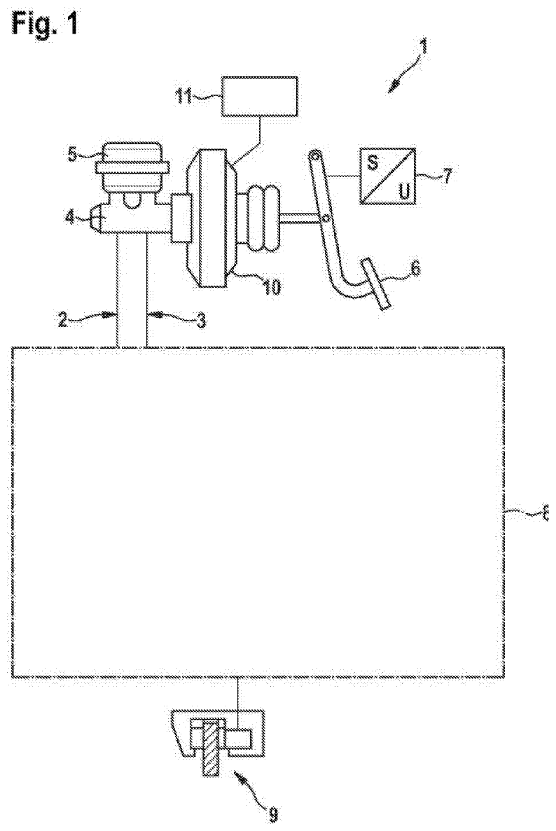

FIG. 1 shows a schematic representation of a hydraulic vehicle brake, wherein the wheel braking device in the vehicle brake on the

rear axle of the vehicle additionally comprises a respective electromechanical braking device with an electric brake motor,

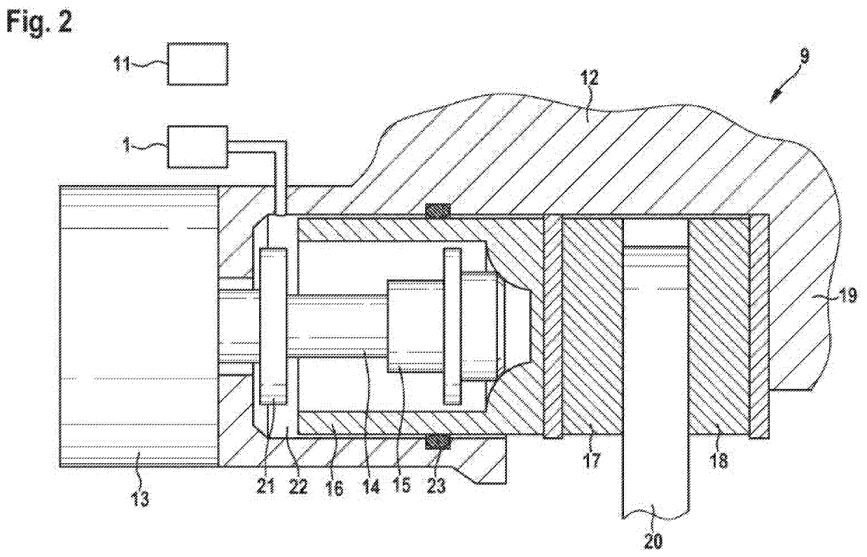

FIG. 2 shows a section through an electromechanical braking device with an electric brake motor,

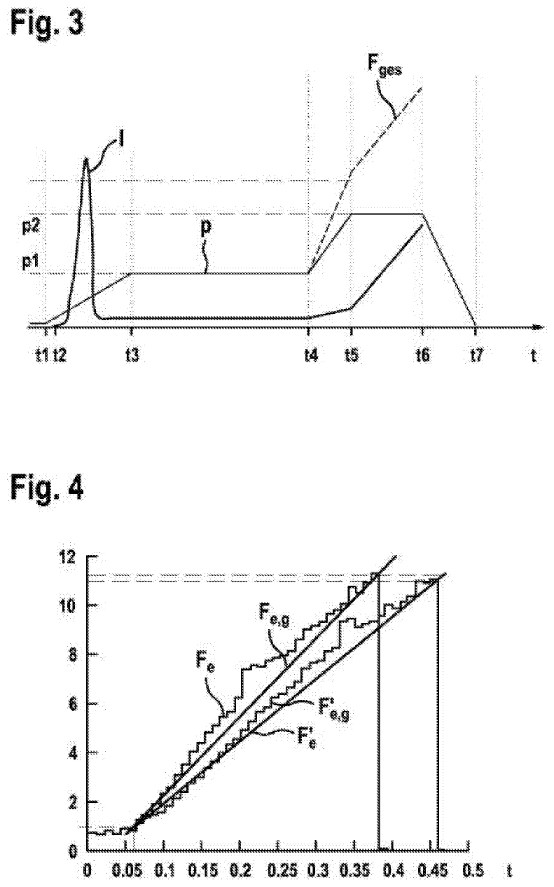

FIG. 3 shows a graph with the variation with time of the motor current of the electric brake motor, the hydraulic braking pressure and the total braking force,

FIG. 4 shows a graph with the electromechanical increase in braking force for the correct hydraulic braking pressure and for a malfunction in the hydraulic vehicle brake,

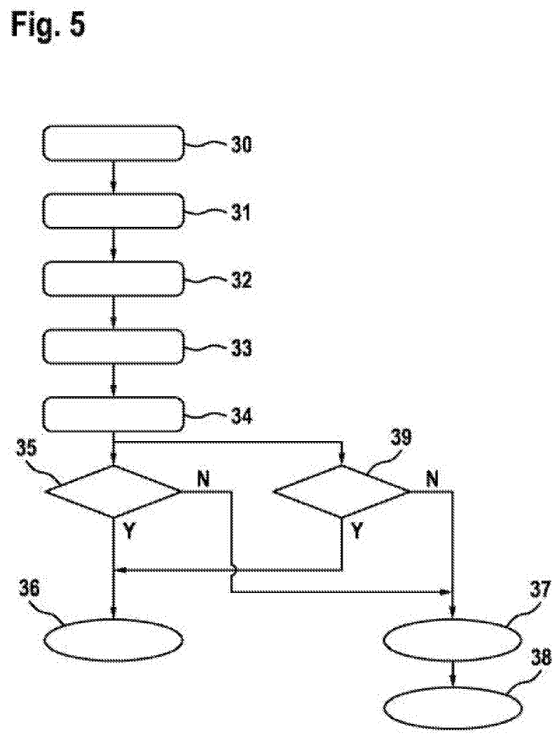

FIG. 5 shows a flow chart of a method of monitoring the braking force in a first version of an embodiment,

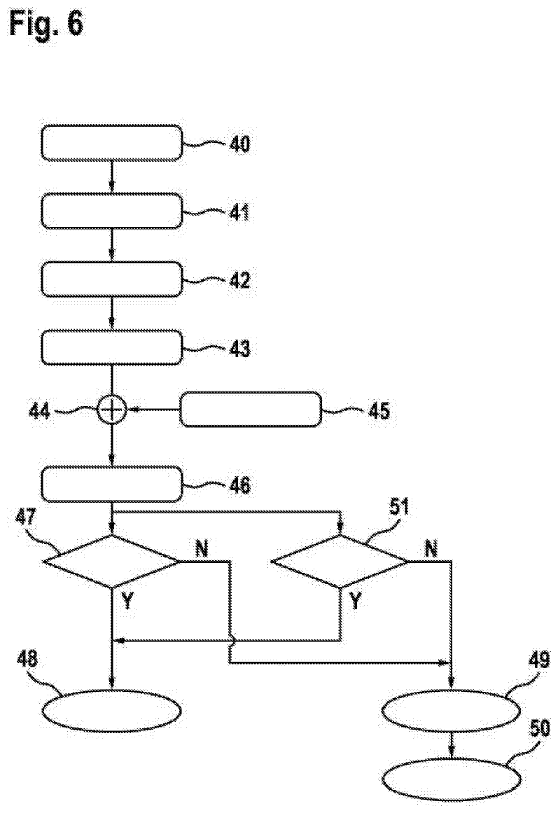

FIG. 6 shows a flow chart for monitoring the braking force in a further version of an embodiment.

In the figures, identical components are provided with the same reference characters.

The hydraulic vehicle brake 1 for a vehicle represented in FIG. 1 comprises a front axle brake circuit 2 and a rear axle brake circuit 3 for supplying and actuating wheel braking devices 9 on each wheel of the vehicle with a brake fluid under hydraulic pressure. The two brake circuits 2, 3 are connected to a common master brake cylinder 4, which is supplied with brake fluid by means of a brake fluid reservoir container 5. The piston of the master brake cylinder within the master brake cylinder 4 is operated by the driver by means of the brake pedal 6, and the pedal travel exerted by the driver is measured by means of a pedal travel sensor 7.

Between the brake pedal 6 and the master brake cylinder 4 there is a braking force booster 10, which for example comprises a pump motor that preferably operates the master brake cylinder 4 via a gear box (iBooster). The braking force booster 10 forms an electrically controllable actuator for influencing the braking pressure.

The actuation movement of the brake pedal 6 measured by the pedal travel sensor 7 is transmitted as a sensor signal to a regulating unit or control unit 11, in which actuating signals for actuating the braking force booster 10 are produced. The supply of the wheel braking devices 9 with brake fluid is carried out in each brake circuit 2, 3 via different switching valves, which in common with further units are part of brake hydraulics 8. The brake hydraulics 8 include furthermore a hydraulic pump that is a component of an electronic stability program (ESP). Also, the pump motor of the ESP hydraulic pump forms an electrically controllable actuator for influencing the braking pressure.

The braking force boosting can additionally or alternatively be carried out using an electrically actuatable actuator that is connected downstream of the master brake cylinder 4 of the vehicle brake 1. In the case of the actuator, the boosting is provided by means of an electric motor that displaces a plunger, for example. Said plunger is mounted after the master brake cylinder and can produce braking pressure in the two brake circuits.

In FIG. 2, the wheel braking device 9, which is disposed on a wheel on the rear axle of the vehicle, is represented in detail. The wheel braking device 9 is part of the hydraulic vehicle brake 1 and is supplied with brake fluid 22 from the rear axle brake circuit. The wheel braking device 9 comprises moreover an electromechanical braking device, which is preferably used to hold a vehicle at a standstill but can also be used to decelerate the vehicle while the vehicle is moving, in particular at lower vehicle speeds below a speed limit value.

The electromechanical braking device comprises a brake caliper 12 with a claw 19 that straddles a brake disk 20. As an actuator the braking device comprises a dc electric motor as a brake motor 13, the rotor shaft of which drives a spindle 14 rotationally, on which a spindle nut 15 is rotatably supported. During rotation of the spindle 14, the spindle nut 15 is displaced axially. The spindle nut 15 moves within a brake piston 16 that forms the support for a brake lining 17 that is forced against the brake disk 20 by the brake piston 16. On the opposite side of the brake disk 20 there is a further brake lining 18 that is mounted positionally fixedly on the claw 19. The brake piston 16 is sealed flow-tight relative to the accommodating housing on the outside thereof by means of an enveloping sealing ring 23.

Within the brake piston 16, the spindle nut 15 can move axially forwards towards the brake disk 20 during a rotary motion of the spindle 14 or during an opposite rotary motion of the spindle 14 can move axially rearwards until reaching a stop 21. To produce a clamping force the spindle nut 15 acts upon the inner end face of the brake piston 16, whereby the brake piston 16, which is axially displaceably supported in the braking device, is forced with the brake lining 17 against the facing end face of the brake disk 20.

For the hydraulic braking force, the hydraulic pressure of the brake fluid 22 from the hydraulic vehicle brake 1 acts on the brake piston 16. The hydraulic pressure can also act in support when the vehicle is at a standstill on operating the electromechanical braking device, so that the total braking force is made up of the component provided by the electric motor and the hydraulic component. While the vehicle is being driven, either only the hydraulic vehicle brake is active, or both the hydraulic vehicle brake and the electromechanical braking device are active or only the electromechanical braking device is active to produce braking force. The actuating signals for actuating both the adjustable components of the hydraulic vehicle brake 1 and the electromechanical wheel braking device 9 are produced in the regulating unit or control unit 11.

In FIG. 3, a diagram with electrical and hydraulic state variables during a clamping process for holding the vehicle at a standstill are represented. At the point in time t₁, a hydraulic braking pressure p is produced by means of an electrically controllable actuator of the hydraulic vehicle brake, for example by operating the ESP pump. At the point in time t₃, the hydraulic braking pressure reaches the first level p₁.

At the point in time t₂, the energization of the electric brake motor begins with the motor current I, which falls to a zero load current value after an initial pulse and maintains said value over the period of time between t₃ and t₄. At the point in time t₃, the hydraulic braking pressure p reaches a bias pressure value, which is maintained until the point in time t₄; the phase between t₃ and t₄ is the zero load phase of the electric brake motor.

At the point in time t₄, an electromechanical braking force is produced by means of the electric brake motor and the motor current I correspondingly increases starting from the level of the zero load current. Also, the hydraulic braking pressure p increases further starting from the first level p₁, so that a total braking force F_{ges} is set by superimposing the hydraulic and electromechanical braking forces. At the point in time t₅, the hydraulic braking pressure reaches the maximum p₂ thereof, which is maintained until the point in time t₆ and then decreases to 0 again until the point in time t₇. In the period of time between t₅ and t₆, the electromechanical braking force, which varies in synchronism with the brake current I, increases until reaching a maximum.

In FIG. 4, the actual profile of the motor current during the increase in braking force with and without hydraulic bias pressure is represented; the input electromechanical braking force Fₑ or F′ₑ corresponds to said motor current. In the case of a functional hydraulic vehicle brake, the actual profile Fₑ of the electromechanical braking force is set, which has a steeper gradient relative to a profile F′ₑ that characterizes the profile in the event of a malfunction of the hydraulic vehicle brake. The associated gradients are characterized by F_{e,g} or F′_{e,g}; the gradients are defined by the start point and end point of the respective electromechanical increase in braking forces Fₑ and F′ₑ. It can be seen that the gradient F_{e,g}, which corresponds to the correct increase in braking force, is steeper than the gradient F′_{e,g}, which indicates too low a hydraulic braking pressure in the hydraulic vehicle brake. Too low a hydraulic braking pressure in the wheel braking device arises in the event of a disconnected hydraulic line, for example.

The hydraulic malfunction can be detected using the gradient F_{e,g} of the increase in braking force. In the event of a malfunction, the smaller gradient F′_{e,g} exists, which can be detected using a comparison with a reference value.

In FIG. 5, a flow chart for monitoring the braking force is represented. First, the start of a braking process for holding the vehicle at a standstill is carried out in the first step 30. In the step 31, a hydraulic braking pressure for producing a hydraulic clamping force is applied by activating an actuator in the hydraulic vehicle brake, such as for example the ESP pump.

Subsequently, in the next step 32 an electromechanical clamping force is produced by actuating the electric brake motor. In the next step 33, the increase in the clamping force Fₑ is determined using the motor current of the brake motor, and in the step 34 the gradient F_{e,g} is formed from the increase in the braking force Fₑ or the corresponding current profile.

In the next step 35, the query is carried out as to whether the gradient of the electromechanical increase in braking force or the motor current lies within a permissible range of values, which is determined by comparison with a reference value. If this is the case, the Yes branch (“Y”) then moves on to the next step 36, and the parking brake process is terminated properly.

The query in the step 35 as to whether the gradient of the increase in braking force lies within the permissible range of values is carried out for all wheel braking devices at which an electromechanical braking device with a brake motor is also effective. For example, this concerns wheel braking devices on the left and right of the rear axle of the vehicle.

If the query in the step 35 reveals that there is an inadequate gradient of the electromechanical increase in braking force in at least one wheel braking device with an electric brake motor, the No branch (“N”) is consequently advanced to the step 37. In this case, the build-up of braking force for producing a parking brake force fails, and a fault signal is produced in the next step 38. The vehicle may be able to be secured by means of the drive train to prevent unwanted rolling away by the vehicle.

Following the step 34, moreover, an additional query is carried out in the step 39, in which the gradients of the electromechanical increase in braking force in at least two different wheel braking devices are compared with each other, for example in the wheel braking devices on the left and right on the rear axle. In the case of correct functioning of the hydraulic vehicle brake, the gradients of the increase in braking force or the associated motor currents must be at least approximately equal in magnitude. If the comparison in step 39 reveals that this is the case, the Yes branch is consequently advanced to the step 36 and the production of the parking brake force is successfully completed.

On the other hand, if the query in the step 39 reveals that the gradient of the increases in braking force in the different wheel braking devices differ in an impermissible manner, the No branch is consequently advanced to the steps 37 and 38 and a corresponding fault signal is produced.

In FIG. 6, a flow chart for testing and monitoring the braking force when carrying out a parking brake process is represented. The first steps 40, 41 and 42 correspond to the steps 30, 31 and 32 of FIG. 5. Following the start of the clamping process or the parking brake process, first a hydraulic braking pressure is produced and then an electromechanical braking force is produced by actuating the electric brake motor.

In the step 43, the current stiffness of the brake caliper is determined. This can be carried out computationally based on current system and characteristic values, inter alia the current hydraulic braking pressure and the temperature.

In the step 44, the stiffness of the brake caliper from a preceding pass through 45 is added to the current stiffness of the brake caliper, wherein the components can be averaged. Accordingly, an averaged current stiffness of the brake caliper results in the step 46. This is compared in the next step 47 with a reference value, in particular with the stiffness of the brake caliper determined in the preceding clamping process. The comparison is carried out for all wheel braking devices on which an electromechanical braking device is disposed.

If the result of the check is that the current stiffness of the brake caliper determined in the step 46 agrees with the preceding value with sufficient accuracy, the Yes branch is consequently advanced to the step 48 and the generation of the parking brake force is concluded.

On the other hand, if the result of the query in the step 47 is that there is an impermissibly large deviation in the brake caliper stiffnesses, the No branch is consequently advanced to the steps 49 and 50 and a fault signal is generated. The steps 49 and 50 correspond to the steps 37 and 38 of FIG. 5.

In addition, in the step 51, which also follows directly on from the step 46, the brake caliper stiffnesses in the different wheel braking devices are compared with each other. If said stiffnesses agree with sufficient accuracy, the Yes branch is consequently advanced to the step 48 and the parking brake process is successfully concluded. Otherwise, the No branch is consequently advanced to the steps 49 and 50 and a fault signal is produced.

1. A method for monitoring a braking force in a vehicle, a braking system of the vehicle including a hydraulic vehicle brake and at least one electromechanical braking device with an electric brake motor for producing a braking force, the method comprising:
causing a hydraulic braking pressure of the hydraulic vehicle brake and the braking force of the electric brake motor to act simultaneously on a brake piston of a wheel braking device; and
producing a fault signal corresponding to a low hydraulic braking pressure in the hydraulic vehicle brake when a gradient of an electromechanical increase in the braking force or a corresponding variable lies outside a permissible range of values.

2. The method as claimed in claim 1, further comprising:
forming the gradient from start and end points of the electromechanical increase in the braking force or the corresponding variable.

3. The method as claimed in claim 1, further comprising:
determining the permissible range of values empirically.

4. The method as claimed in claim 1, further comprising:
determining a reference value characterizing the permissible range of values from stiffness of a brake caliper of a wheel braking device.

5. The method as claimed in claim 4, further comprising:
determining and updating the stiffness of the brake caliper during each braking process.

6. The method as claimed in claim 1, further comprising:
comparing the electromechanical increase in braking force or a corresponding variable in two different wheel braking devices with each other.

7. The method as claimed in claim 1, wherein a variable corresponding to the electromechanical increase in braking force is a motor current of the electric brake motor.

8. The method as claimed in claim 1, wherein a variable corresponding to the electromechanical increase in braking force is a stiffness of a brake caliper of the wheel braking device.

9. The method as claimed in claim 1, wherein during generation of the braking force, start of generating the hydraulic braking pressure precedes the electromechanical increase in braking force.

10. The method as claimed in claim 1, wherein a regulating unit or control unit is configured to perform the method.

11. A braking system in a vehicle, comprising:
a hydraulic vehicle brake;
an electromechanical braking device including an electric brake motor; and
a regulating unit or control unit configured to:
actuate adjustable components of the braking system;
cause a hydraulic braking pressure of the hydraulic vehicle brake and the brake force of the electric brake motor to act simultaneously on a brake piston of a wheel braking device; and
produce a fault signal that corresponds to a low hydraulic braking pressure in the hydraulic vehicle brake when a gradient of an electromechanical increase in the braking force or a corresponding variable lies outside a permissible range of values.

12. The braking system as claimed in claim 11, further comprising:
the hydraulic vehicle brake having an electrically controllable actuator configured to influence the hydraulic pressure.

13. The braking system as claimed in claim 12, wherein the electrically controllable actuator is an ESP pump.
